(19) United States
(12) Patent Application Publication
(10) Pub. No.: US 2022/0234695 A1
(43) Pub. Date: Jul. 28, 2022

(54) BABY FLOAT WITH MASSAGE FUNCTION

(71) Applicant: Zhejiang Mambobaby Baby Products Co., Ltd., Yiwu (CN)

(72) Inventor: Weixin Zhou, Jinhua (CN)

(73) Assignee: Zhejiang Mambobaby Baby Products Co., Ltd., Yiwu (CN)

(21) Appl. No.: 17/722,427

(22) Filed: Apr. 18, 2022

(30) Foreign Application Priority Data
Mar. 3, 2022 (CN) 202220448031.3

(51) Int. Cl. B63B 34/50; A61H 9/00

(52) U.S. Cl. CPC B63B 34/50; A61H 9/005

(57) ABSTRACT

The present invention proposes a baby float with a massage function, which includes a float body and further includes a bubble massage component. The bubble massage component includes an air pump and an air pipe; an air outlet end of the air pump is communicated with the air pipe; and the air pipe is arranged below the float body. In the baby float, the air pipe with air holes is arranged below the float body so that the air holes can be underwater when used, and the air pump can be activated to blow out bubbles from the air holes of the air pipe. The bubbles break when coming into contact with the body of a baby, to play a role of massage.

### TECHNICAL FIELD

The present invention relates to the technical field of articles for swimming, and particularly relates to a baby float with a massage function.

### BACKGROUND

At present, the baby floats mainly include a neck type and an axillary type. The neck type float is easy to injure the cervical vertebrae of the infant and may severely compress the trachea to suffocate the infant. The axillary type float is easy to generate buoyancy imbalance, causing a user to roll. Other types of floats also have some potential safety hazards. Because the floats and the infant are not fixed firmly, the infant is separated from the floats and the infant falls into the water.

To solve the above problems, the applicant proposes a lying ring for infants to China National Intellectual Property Administration, with publication number of CN209479928U. The lying ring adopts a wearable adjustment positioning structure, which not only can fix a baby firmly, hut also can reduce the hidden danger of safety. Moreover, the length of shoulder straps and a crotch connecting strap can be adjusted in place at one time without the need of separate wearing adjustment; wearing is simple, and time consumption is short.

The above technical solution has advantages, but has no massage function. Because many babies are basically in a static floating state on the float and body movement is less, good body stretching and massage effects cannot be achieved through swimming. In addition, the existing float does not have a temperature measurement function, and water temperature cannot be monitored in real time.

### SUMMARY

The purpose of the present invention is to solve the problems in the prior art to propose a baby float with a massage function, which can blow out bubbles underwater and contact with the body of the baby. The rupture process of the bubbles plays a role of massage.

To achieve the above purpose, the present invention proposes a baby float with a massage function, which comprises a float body and further comprises a bubble massage component; the bubble massage component comprises an air pump and an air pipe; an air outlet end of the air pump is communicated with the air pipe; and the air pipe is arranged below the float body.

Preferably, the baby float further comprises a control box; a battery and an air pump are arranged in the control box; the battery is used for supplying power for the air pump; and a panel of the control box is provided with a switch to control the opening or closing of the air pump.

Preferably, the baby float further comprises a temperature measuring probe extending from the control box; the temperature measuring; probe is used for monitoring water temperature; the panel of the control box is provided with a temperature display screen; and the temperature display screen is electrically connected with the temperature measuring probe for displaying the water temperature.

Preferably, a music player is also installed in the control box.

Preferably, an auxiliary supporting frame is also arranged below the float body, and the air pipe is fixedly installed in the auxiliary supporting frame.

Preferably, the lower part of the float body is connected with a chest supporting pad, and the air pipe is arranged in the chest supporting pad.

Preferably, a plurality of air holes are formed in the surface of the air pipe.

Preferably, the air outlet end of the air pipe is connected with an air outlet module having a plurality of vent holes, The air outlet module can adopt oxygen-increasing air stone.

Preferably, the air outlet end of the air pump is connected with a shunt through an air supply mother pipe, and the shunt is connected with a plurality of air pipes.

Preferably, the baby float further comprises a protection component; the protection component comprises a first shoulder strap, a second shoulder strap, a crotch connecting strap, a left back protection pad and a right back protection pad; an inner ring of the float body is connected with the left back protection pad and the right back protection pad; one end of the first shoulder strap and the second shoulder strap extends to the left back protection pad and the right back protection pad; and the other end of the first shoulder strap and the second shoulder strap can be detachably connected with the crotch connecting strap through a connecting piece.

The present invention has the following beneficial effects:

1. The air pipe with air holes is arranged below the float so that the air holes can be underwater when used, and the air pump can be activated to blow out bubbles from the air holes of the air pipe. The bubbles break when coming into contact with the body of a baby, to play a role of massage.

2. The temperature measuring probe is added on the control box, and can be used for measuring the water temperature in real time and displaying the water temperature in real time on the temperature display screen.

3. The function of music playing is added, which can soothe the baby and relieve the emotions of the baby.

The features and advantages of the present invention will be described in detail through embodiments and in combination with the drawings.

### DESCRIPTION OF DRAWINGS

FIG. 1 is an internal structural schematic diagram of embodiment 1 of the present invention;

FIG. 2 is an internal structural schematic diagram of embodiment 2 of the present invention;

FIG. 3 is a top structural schematic diagram of embodiment 2 of the present invention;

FIG. 4 is a top schematic diagram of a bubble massage component of embodiment 2 of the present invention;

FIG. 5 is a left schematic diagram of an air pipe of embodiment 2 of the present invention;

FIG. 6 is a top schematic diagram of a bubble massage component of embodiment 3 of the present invention;

FIG. 7 is a top schematic diagram of a bubble massage component of embodiment 4 of the present invention; and

FIG. 8 is a top schematic diagram of a bubble massage component of embodiment 5 of the present invention.

### DETAILED DESCRIPTION

### Embodiment 1

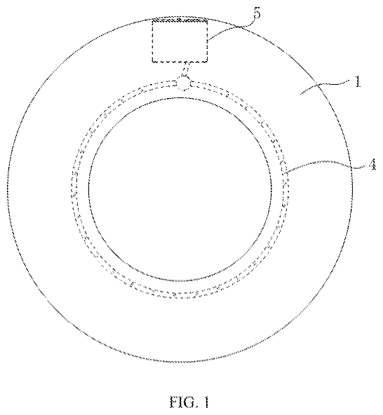

By referring to FIG. 1, the present invention provides a baby float with a massage function, which includes a float body 1 and further includes a bubble massage component 4. The bubble massage component 4 includes an air pump and an air pipe 41; an air outlet end of the air pump is communicated with the air pipe 41; and the air pipe 41 is arranged below the float body 1. The float body 1 may be a closed annular float or a non-closed U-shaped float.

Further, the baby float further comprises a control box 5; a battery and an air pump are arranged in the control box 5; the battery is used for supplying power for the air pump; and a panel of the control box 5 is provided with a switch 51 to control the opening or closing of the air pump. in the present embodiment, a battery compartment and an air pump compartment are also arranged in the control box 5; the air pump is installed in the air pump compartment; and the battery is installed in the battery compartment.

Further, the baby float further comprises a temperature measuring probe extending from the control box 5; the temperature measuring probe is used for monitoring water temperature; the panel of the control box 5 is provided with a temperature display screen 52; and the temperature display screen 52 is electrically connected with the temperature measuring probe for displaying the water temperature to help parents to confirm whether the water temperature is suitable for swimming and prevent cold caused by unsuitable water temperature.

Further, a music player 6 is also installed in the control box 5. Music can be played according to needs to soothe the baby and relieve the emotions of the baby.

Further, an auxiliary supporting frame is also arranged below the float body 1, and the air pipe 41 is fixedly installed in the auxiliary supporting frame.

### Embodiment 2

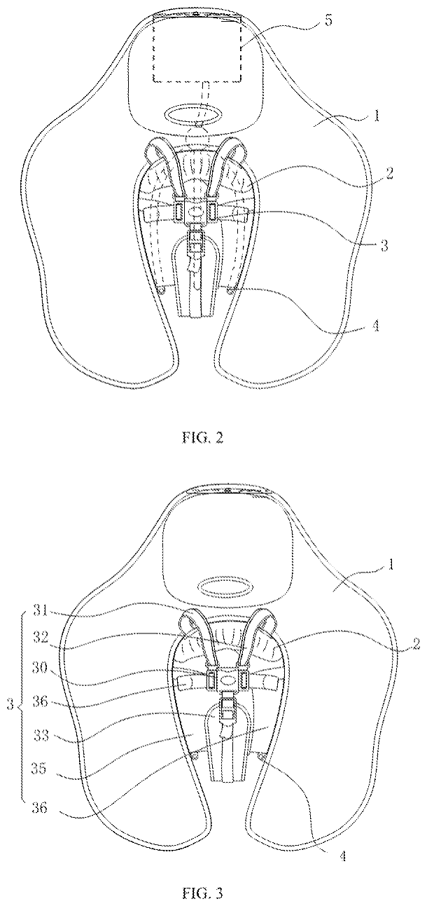

By referring to FIG. 2 to FIG. 3, based on embodiment 1, the present embodiment also comprises a chest supporting pad 2 and a protection component 3. Specifically, the lower part of the float body 1 is connected with the chest supporting pad 2, and the air pipe 41 is arranged in the chest supporting pad 2.

Further, by referring to FIG. 3, the protection component 3 comprises a first shoulder strap 31, a second shoulder strap 32, a crotch connecting strap 33, a left back protection pad 34 and a right back protection pad 35; an inner ring of the float body 1 is connected with the left back protection pad 34 and the right back protection pad 35; one end of the first shoulder strap 31 and the second shoulder strap 32 extends to the left back protection pad 34 and the right back protection pad 35; and the other end of the first shoulder strap 31 and the second shoulder strap 32 can be detachably connected with the crotch connecting strap 33 through a connecting piece 30. A user can be bound within a certain range through the first shoulder strap 31, the second shoulder strap 32, the crotch connecting strap 33, chest protection straps 36 and the like, to reduce the movement range of the user on the water and avoid the problem of easy rollover. The connecting piece 30 is one of a buckle, a fastener, an eyesplice and a button. The left back protection pad 34 and the right back protection pad 35 are detachably connected through an auxiliary connecting piece. The auxiliary connecting piece is one of a fastener, an eyesplice, a velcro and a button. Water permeable holes are evenly distributed on the left back protection pad 34 and the right back protection pad 35, so that the water can penetrate into the upper surface to enable the body of the user to come into contact the bubble water produced by the bubble massage component 4.

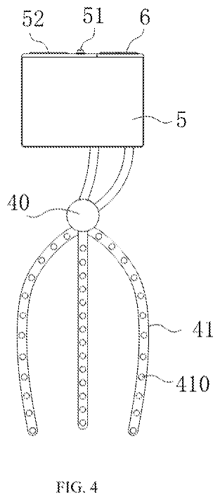

Further, by referring to FIG. 4 and FIG. 5, the air pipe 41 has a concave arc structure, and a plurality of air holes 410 are formed in the surface. The air outlet end of the air pump is connected with a shunt 40 through an air supply mother pipe, and the shunt 40 is connected with a plurality of air pipes 41. The bubble massage component 4 is provided with three air pipes 41 arranged in an inverted epsilon type, including a middle air pipe and edge air pipes symmetrically arranged on both sides of the middle air pipe.

### Embodiment 3

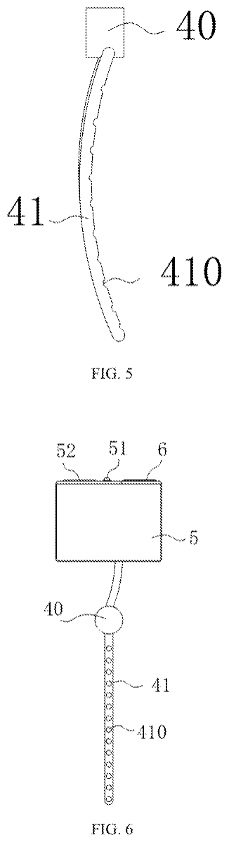

By referring to FIG. 6, the present embodiment is different from embodiment 2 in that: only one air pipe 41 is arranged, and bubbles are blown through the air holes 410 in the surface of the air pipe 41.

### Embodiment 4

By referring to FIG. 7, the present embodiment is different from embodiment 3 in that: no air hole 410 is arranged on the air pipe 41, but the air outlet end of the air pipe 41 is connected with an air outlet module 42 having a plurality of vent holes. The bubbles are blown through the air outlet module 42. The air outlet module can adopt oxygen-increasing air stone.

### Embodiment 5

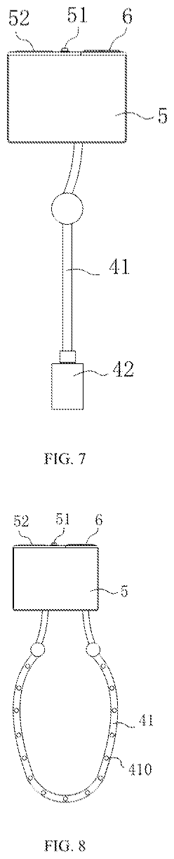

By referring to FIG. 8, the present embodiment is different from embodiment 2 in that: only one arc-shaped air pipe 41 is arranged, and both ends of the air pipe 41 are communicated with two air pumps. The two air pumps can blow air simultaneously into one closed air pipe 41. The bubbles are blown through the air holes 410 in the surface of the air pipe 41.

The use process of the present invention is as follows:

By taking embodiment 2 as an example, before use, firstly, the abdomen of the baby is placed on the chest supporting cushion 2, and the left back protection pad 34 and the right back protection pad 35 are pulled to the waist position of the baby and detachably connected by the auxiliary connecting piece. Then, plugs on the first shoulder strap 31, the second shoulder strap 32 and the two chest protection straps 36 are inserted into the connecting piece 30. The crotch connecting strap 33 is used for fixing the crotch of the baby to prevent down slide. Finally, the crotch connecting strap 33 and the shoulder straps are adjusted to optimum length by adjusting the length of the crotch connecting strap 33 according to the actual size of the baby, and then are connected with the connecting piece 30 to fix the baby firmly.

In use, the switch 51 is pressed to open the air pump. When the air pump blows, a plurality of air holes 410 of the air pipe 41 below the water surface continuously blow out bubbles at the waist and abdomen of the baby to achieve the effect of massage. Parents can check the water temperature through the temperature display screen 52, and can play music to relieve the nervous emotion of the baby.

The above embodiments are explanations of the present invention, not limitations to the present invention. Any solution after simple transformation of the present invention shall belong to the protection scope of the present invention.

What is claimed is:

1. A baby float with a massage function, comprising a float body (1), and further comprising a bubble massage component (4), wherein the bubble massage component (4) comprises an air pump and an air pipe (41); an air outlet end of the air pump is communicated with the air pipe (41); and the air pipe (41) is arranged below the float body (1).

2. The baby float with the massage function according to claim 1, further comprising a control box (5), wherein a battery and an air pump are arranged in the control box (5); the battery is used for supplying power for the air pump; and a panel of the control box (5) is provided with a switch (51) to control the opening or closing of the air pump.

3. The baby float with the massage function according to claim 2, further comprising a temperature measuring probe extending from the control box (5), wherein the temperature measuring probe is used for monitoring water temperature; the panel of the control box (5) is provided with a temperature display screen (52); and the temperature display screen (52) is electrically connected with the temperature measuring probe for displaying the water temperature.

4. The baby float with the massage function according to claim 2, wherein a music player (6) is also installed in the control box (5).

5. The baby float with the massage function according to claim 1, wherein an auxiliary supporting frame is also arranged below the float body (1), and the air pipe (41) is fixedly installed in the auxiliary supporting frame.

6. The baby float with the massage function according to claim 2, wherein an auxiliary supporting frame is also arranged below the float body (1), and the air pipe (41) is fixedly installed in the auxiliary supporting frame.

7. The baby float with the massage function according to claim 3, wherein an auxiliary supporting frame is also arranged below the float body (1), and the air pipe (41) is fixedly installed in the auxiliary supporting frame.

8. The baby float with the massage function according to claim 4, wherein an auxiliary supporting frame is also arranged below the float body (1), and the air pipe (41) is fixedly installed in the auxiliary supporting frame.

9. The baby float with the massage function according to claim 1, wherein the lower part of the float body (1) is connected with a chest supporting pad (2), and the air pipe (41) is arranged in the chest supporting pad (2).

10. The baby float with the massage function according to claim 1, wherein a plurality of air holes (410) are formed in the surface of the air pipe (41).

11. The baby float with the massage function according to claim 1, wherein the air outlet end of the air pipe (41) is connected with an air outlet module (42) having a plurality of vent holes.

12. The baby float with the massage function according to claim 1, wherein the air outlet end of the air pump is connected with a shunt (40) through an air supply mother pipe, and the shunt (40) is connected with a plurality of air pipes (41).

13. The baby float with the massage function according to claim 1, further comprising a protection component (3), wherein the protection component (3) comprises a first shoulder strap (31), a second shoulder strap (32), a crotch connecting strap (33), a left back protection pad (34) and a right back protection pad (35); an inner ring of the float body (1) is connected with the left back protection pad (34) and the right back protection pad (35); one end of the first shoulder strap (31) and the second shoulder strap (32) extends to the left back protection pad (34) and the right back protection pad (35); and the other end of the first shoulder strap (31) and the second shoulder strap (32) can be detachably connected with the crotch connecting strap (33) through a connecting piece (30).
